(19) United States
(12) Patent Application Publication
(10) Pub. No.: US 2009/0285505 A1
(43) Pub. Date: Nov. 19, 2009

(54) IMAGE PROCESSING METHOD, IMAGE PROCESSING APPARATUS, AND IMAGE FORMING APPARATUS

(76) Inventors: Koichi MIHARA, Osaka (JP); Yasuyuki ISHIGURO, Osaka (JP)

Correspondence Address: BIRCH STEWART KOLASCH & BIRCH, PO BOX 747, FALLS CHURCH, VA, 22040-0747, US

(21) Appl. No.: 12/464,967

(22) Filed: May 13, 2009

(30) Foreign Application Priority Data
May 14, 2008 (JP) 2008-127478

(51) Int. Cl. G06K 9/36; G06K 9/32

(52) U.S. Cl. 382/284; 382/298

(57) ABSTRACT

When a predetermined processing is performed on image data, a target area to be subjected to the predetermined processing in an image based on the image data is received, the predetermined processing is performed only on the target area, a position of a processed image in the target area where the predetermined processing is performed is changed, and the processed image and a non-target image in a non-target area except for the target area are synthesized with each other. When the synthesis is performed, an overlapped area where the non-target image and the processed image overlap with each other is extracted, and processing for reflecting image density data of the processed image and that of the non-target image at a predetermined ratio is performed, with respect to the extracted overlapped area.

### CROSS-REFERENCE TO RELATED APPLICATIONS

This Nonprovisional application claims priority under 35 U.S.C.§119(a) on Patent Application No. 2008-127478 filed in Japan on May 14 2008, the entire contents of which are hereby incorporated by reference.

### BACKGROUND OF THE INVENTION

1. Technical Field

The present invention relates to an image processing method and an image processing apparatus for performing a processing to image data, and an image forming apparatus for forming an image according to the processed image data.

2. Description of Related art

Conventionally, in an image processing apparatus or an image forming apparatus such as a digital multi-function peripheral having a copy function, a printing function, a facsimile function, and the like, image data of a document is obtained through a scanner (image reading unit), the obtained image data is subjected to a variable magnification processing of enlargement or reduction, and an image is formed on a recording paper based on the image data after the variable magnification processing, thereby executing a so-called variable magnification copy.

However, such a conventional image processing apparatus or image forming apparatus performs the variable magnification processing for enlarging or reducing a whole area of the document even when a user requires the variable magnification copy of only a partial area of the document, the variable magnification processing and the image formation are performed even on an area where the variable magnification processing is not required, thus causing a problem of efficiency.

In order to improve such a problem, Japanese Patent Application Laid-Open No. 2004-221898 discloses an image forming apparatus, in which a target area that the user wants to enlarge or reduce is designated with a specific marker, in the document, and only the designated target area is extracted from the obtained image data of the document to thereby enlarge or reduce it according to a size of the recording paper, or a recording paper suitable for a size of the target area designated with the marker is automatically selected to record and output it.

### BRIEF SUMMARY OF THE INVENTION

In the image forming apparatus disclosed in Japanese Patent Application Laid-Open No. 2004-221898, however, an area that is not designated with the marker, namely, a non-target area that is not set as the target area is not subjected to the variable magnification processing, so that it has a problem that the image data in the non-target area is lost. Namely, it is impossible not only to compare the image in the target area after the variable magnification processing with the image in the non-target area, but also to form both of these images on the recording paper, together.

The present invention has been made in view of the situation described above, and an object thereof is to provide an image processing method, an image processing apparatus, and an image forming apparatus, which can, when a predetermined processing is performed on image data, receive a target area to be subjected to the predetermined processing, in an image based on the image data, perform the predetermined processing only on the target area, change a position of an image (processed image) in the target area after the predetermined processing to synthesize it with an image (non-target image) in a non-target area except for the target area, and thus perform the predetermined processing only on the target area, and also after the predetermined processing, display both of the processed image and the non-target image, compare the processed image with the non-target image, and form both of the processed image and the non-target image on a recording sheet without losing the image data in the non-target area.

An image processing apparatus in accordance with the present invention comprises, in an image processing apparatus for performing processing on image data, an area receiving means for receiving a target area to be subjected to the processing in an image based on the image data, and a synthesizing means for changing a position of a processed image in the target area subjected to the processing, and synthesizing the processed image with a non-target image in a non-target area except for the target area.

In the present invention, the area receiving means receives the target area to be subjected to the processing in the image based on the image data, and the processing is performed on the target area. The synthesizing means changes the position of the processed image in the target area after the processing, and synthesizes the processed image with the non-target image in the non-target area except for the target area. The synthesized synthetic image is displayed on a display unit, for example.

The image processing apparatus in accordance with the present invention is provided with a display unit for displaying the image, wherein the area receiving means receives the target area based on the image displayed on the display unit.

In the present invention, the image based on the image data is displayed on the display unit, the user designates the target area using, for example, a cursor displayed on the display unit, while confirming the image, and thus the area receiving means receives the target area.

The image processing apparatus in accordance with the present invention is provided with a position receiving means for receiving a position where the processed image is to be arranged in the synthesis.

In the present invention, when the synthesis is performed by the synthesizing means, the position receiving means receives the position where the processed image is to be arranged, and the position of the processed image in the synthesis is changed according to the position received by the position receiving means.

The image processing apparatus in accordance with the present invention is provided with an extracting means for extracting an overlapped area where the non-target image and the processed image overlap with each other, when the synthesis is performed, and a reflection processing means for performing processing for reflecting image density data of the processed image and that of the non-target image at a predetermined ratio, with respect to the extracted overlapped area.

In the present invention, when the synthesis is performed by the synthesizing means, the extracting means extracts the overlapped area where the non-target image and the processed image overlap with each other, and the reflection processing means performs the processing for reflecting the image density data of the processed image and that of the non-target image with the predetermined ratio, with respect to the extracted overlapped area.

The image processing apparatus in accordance with the present invention is provided with a ratio receiving means for receives the predetermined ratio.

In the present invention, the ratio receiving means receives the predetermined ratio, and the reflection processing means reflects the image density data of the processed image and that of the non-target image to the overlapped area based on the predetermined ratio received by the ratio receiving means.

The image processing apparatus in accordance with the present invention is provided with a color receiving means for receiving a color of an object in the processed image.

In the present invention, the color receiving means receives the color of the object, such as characters, graphics, and the like in the processed image, and the color of the object in the processed image is changed according to the color received by the color receiving means.

The image processing apparatus in accordance with the present invention, in which the processing to be performed is a variable magnification processing, is provided with a magnification rate receiving means for receiving a variable magnification rate in the variable magnification processing.

In the present invention, when the variable magnification processing to the target area is performed, the magnification rate receiving means receives the variable magnification rate, and the variable magnification processing is performed on the target area according to the variable magnification rate received by the magnification rate receiving means.

An image forming apparatus in accordance with the present invention is provided with any one of the aforementioned image processing apparatuses, and an image forming unit for forming an image on a recording sheet based on a synthetic image by the image processing apparatus.

In the present invention, the image processing apparatus receives the target area and performs the predetermined processing on the target area. The processed image after the predetermined processing is synthesized with the non-target image, and the image forming unit forms an image to a recording sheet based on the synthetic image.

According to the present invention, the predetermined processing can be performed only on the target area that is set in the image based on the image data, and the image data in the non-target area is not lost even after the predetermined processing, and thus it is possible to display both of the processed image and the non-target image on the display unit, or to form them on the recording paper, allowing the processed image to be compared with the non-target image, for example.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram showing a principal part configuration of an image processing apparatus and an image forming apparatus in accordance with a first embodiment;

FIGS. 2A-2C are explanatory views for explaining a setting operation of a target area;

FIGS. 3A and 3B are explanatory views for explaining a setting operation of a position of a processed image;

FIG. 4 is a flow chart showing a procedure of CPU in the image processing apparatus and the image forming apparatus;

FIG. 5 is a flow chart showing a procedure of CPU in the image processing apparatus and the image forming apparatus; and

FIG. 6 is a block diagram showing a principal part configuration of an image processing apparatus and an image forming apparatus in accordance with a second embodiment.

### DETAILED DESCRIPTION OF THE INVENTION

Hereinafter, an image processing apparatus and an image forming apparatus in accordance with the present invention will be described concretely based on the drawings. The following description will be given by taking as an example a digital multi-function peripheral having a copy function, a printing function, a facsimile function, and the like as the image processing apparatus and the image forming apparatus in accordance with the present invention.

### First Embodiment

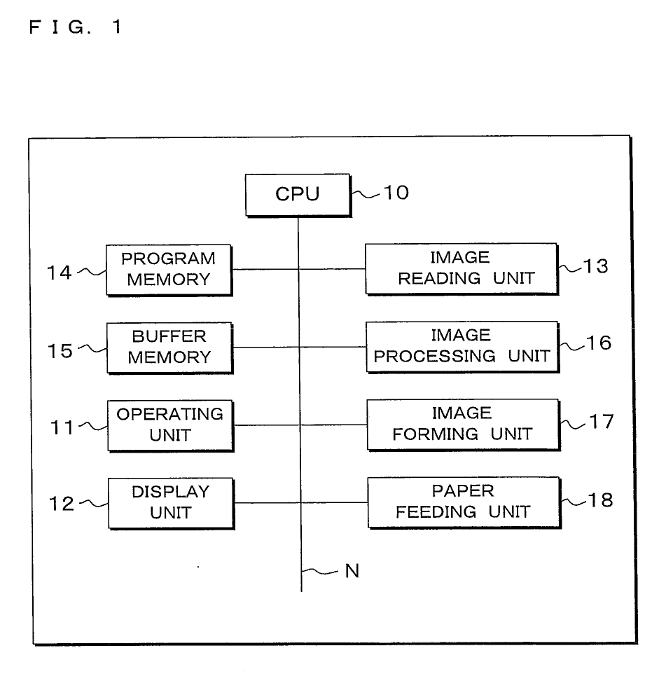

FIG. 1 is a block diagram showing a principal part configuration of an image processing apparatus and an image forming apparatus in accordance with a first embodiment. The image processing apparatus and the image forming apparatus in accordance with the present embodiment is provided with a CPU 10, wherein hardware components such as an operating unit 11, a display unit 12, an image reading unit 13, a program memory 14, a buffer memory 15, an image processing unit 16, an image forming unit 17, a paper feeding unit 18, and the like are connected to the CPU 10 via a bus N. A control program for controlling these hardware components is stored in the program memory 14, and the CPU 10 loads this control program on the buffer memory 15 and executes it as required, so that operation of the whole apparatus is controlled.

The operating unit 11 is provided with hard-keys, such as a copy key for executing the copy function, a printer key for executing the printing function, a fax key for executing the facsimile function, a start key, a ten-key pad, a power key, and the like.

The display unit 12 is constituted by, for example, an LCD (liquid crystal display), a PD (plasma display), and the like, and an image related to an instruction inputted through the operating unit 11, an image of the document based on the image data read by the image reading unit 13, an after-mentioned target area in the document displayed with, for example, reversal of color, a rectangular cursor for setting the target area, an image in the target area after predetermined processing (hereinafter, referred to as processed image), a synthetic image in which the processed image, and an image in a non-target area except for the target area (hereinafter, referred to non-target image) are synthesized, and the like are displayed thereon.

In addition, the display unit 12 is provided with a touch panel arranged on the liquid crystal display, and a plurality of soft-keys (hereinafter, abbreviated as key) are provided on the touch panel. For example, when the copy key is pressed and the copy function is selected, an “area setting” key for setting an area to be a target when performing the predetermined processing only on a partial area of the document, a “variable magnification” key for performing a variable magnification processing on the target area, a “magnification rate setting” key for setting a variable magnification rate when performing the variable magnification processing, a “paper size” key for setting a size of a recording paper, a “position setting” key for setting a position where the processed image should be arranged in the synthesis, each “moving” key related to upper, lower, left, and right directions for cursor movement or size change in the setting of the target area, a “reflection ratio” key for setting a ratio of image density data of the processed image and that of the non-target image, which is reflected to an area (hereinafter, referred to as overlapped area) where the non-target image and the processed image overlap with each other in the synthesis, a “color setting” key for setting a color of an object in the processed image, an “enter” key for fixing an operation, and the like are provided on the touch panel.

Namely, the touch panel of the display unit 12 functions as means for receiving designation of the target area in the image of the document (area receiving section), means for receiving the setting of the variable magnification rate to the target area (magnification rate receiving section), means for receiving the setting of the position of the processed image in the synthesis (position receiving section), means for receiving the setting of the reflection ratio of the image density data of the processed image and that of the non-target image to the overlapped area (ratio receiving section), and means for receiving the setting of the color of the object in the processed image (color receiving section).

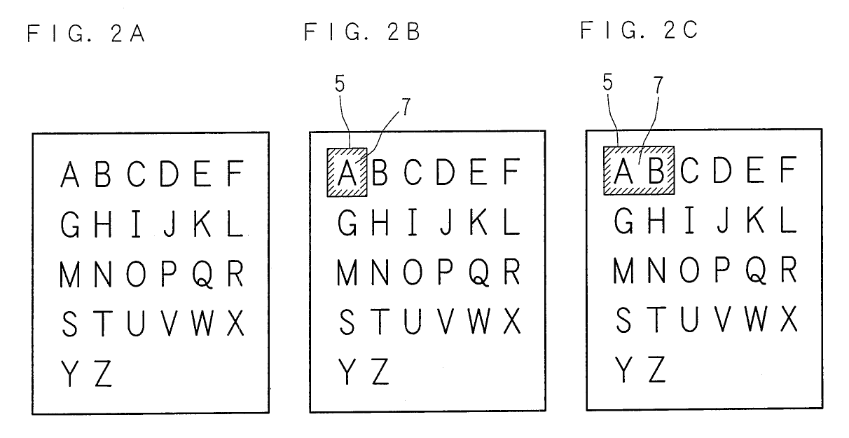

Hereinafter, a setting operation of the target area will be described. FIGS. 2A-2C are explanatory views for explaining the setting operation of the target area. FIG. 2A is a schematic view of the document to be processed, FIG. 2B is the image of the document displayed on the display unit 12 based on the image data read by the image reading unit 13, and FIG. 2C is the image of the document after the setting operation of the target area.

Five lines of the alphabetic characters “A” to “Z” (image) are displayed in the image of the document displayed on the display unit 12. The user of the image processing apparatus and the image forming apparatus in accordance with the present invention can adjust the position or size of the cursor 5 by operating the soft-keys of the touch panel to thereby set the target area. For example, when the user operates the “area setting” key of the touch panel, the cursor 5 is displayed on the display unit 12 (for example, it blinks), and when the user operates any “moving” key, the cursor 5 can be moved in a corresponding direction.

In addition, the cursor 5 is displayed at the uppermost left of the image of the document as a default (FIG. 2B), and when the “moving” key related to the downward direction is operated with the copy key or when the “moving” key related to the rightward direction is operated with the copy key, the size of the cursor 5 is expanded in the downward direction or rightward direction, respectively. Meanwhile, when the “moving” key related to the upward direction is operated with the copy key, or when the “moving” key related to the leftward direction is operated with the copy key, the size of the cursor 5 is reduced in the upward direction or leftward direction, respectively.

After thus adjusting the position or size of the cursor 5, the setting of the target area is fixed by operating the “enter” key. The area delimited by the cursor 5 will be displayed with reversal of color, and the area will correspond to a target area 7. For example, the user can set a character part of “A” and “B” as the target area 7 by operating the “area setting” key and any “moving” key of the touch panel, as shown in FIG. 2C.

The setting of the target area 7 is not limited to the aforementioned example. The target area may be set by configuring such that while confirming the image of the document displayed on the liquid crystal display (display unit 12), a mark such as surrounding the target area or the like is created using a specific marker to allow the marked area to be recognized, for example.

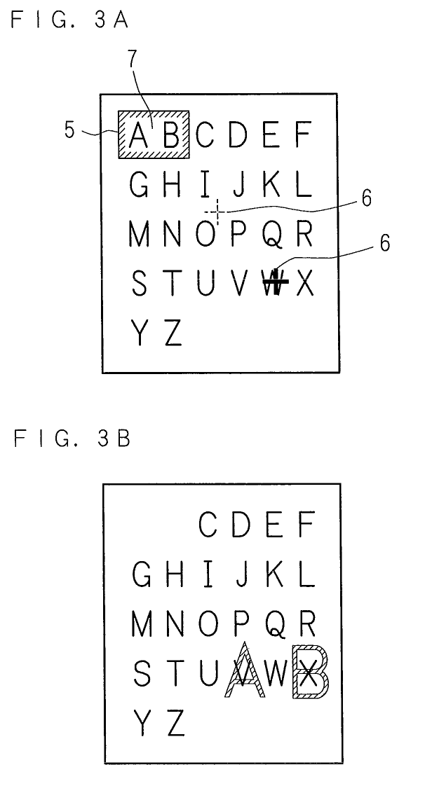

As described above, after the setting of the target area 7 is performed, the user sets the position where the processed image is to be arranged in the synthesis after the predetermined processing. Hereinafter, the setting of the position of the processed image operation will be described. FIGS. 3A and 3B are explanatory views for explaining the setting operation of the position of the processed image.

In the setting operation of the position of the processed image, the user operates the “position setting” key on the touch panel first. A cross mark 6 (indicated by a dotted line in the figure) is blinkingly displayed in the center of the image of the document by the operation of the “position setting” key, as shown in FIG. 3A. The user moves the mark 6 to a suitable position by operating any “moving” key, and fixes the position by operating the “enter” key. Subsequently, the predetermined processing is performed on the target area 7, and the center of the processed image after the predetermined processing is displayed so that it may be aligned with and located at the fixed position. For example, when the position of the processed image is set at the lower right-hand side (it is indicated by a solid line in FIG. 3A) in the image of the document and the target area 7 is subjected to two-times enlargement processing, an image (processed image) enlarged by two times as compared with that before the processing is displayed so as to locate at the lower right-hand side in the image of the document as described above (FIG. 3B). In this case, the object in the processed image is processed in a color received by the operation of the “color setting” key and displayed (it is indicated by hatching in FIG. 3B). For that reason, the processed image can be displayed at a position with few objects.

It is to be noted that although the case where the mark 6 is displayed by the operation of the “position setting” key and the setting is performed by moving the mark 6 in setting the- position of the processed image has been described as an example in the above-mentioned description, the present invention is not limited thereto. For example, it may be configured such that the cursor 5 is activated by the operation of the “position setting” key to be in a movable state, and the cursor 5 is then moved.

The image reading unit 13 is provided with a CCD, a scanner platen, and the like, and it reads the image data related to the manuscript set on the scanner platen as the digital data. The read image data is stored in the buffer memory 15, and the image of the document based on the image data is displayed on the display unit 12.

The program memory 14 is constituted by, for example, ROM, EEPROM, hard disk, and the like, and stores a main routine control program for the CPU 10 to control each hardware, an image forming program for forming the image, a storage control program for storing in the buffer memory 15 the image data read by the image reading unit 13, a buss control program for controlling the bus N, and the like.

The buffer memory 15 is constituted by, for example, RAM, EEPROM, and the like, and temporarily stores data that is temporarily generated in the control by the CPU 10, inputted instruction information, image forming conditions, data related to the processed image after the predetermined processing, image data of the document read by the image reading unit 13, data related to the synthetic image in which the processed image and the non-target image are synthesized, and the like.

The image processing unit 16 reads the image data of the target area and the image data of the non-target area except for the target area from the buffer memory 15 as bit map format, performs the variable magnification processing on the image data of the target area 7 according to the variable magnification rate related to, for example, the setting received through the operating unit 11, and further processes the image data subjected to the variable magnification processing according to the color of the object related to the setting that is received through the operating unit 11. The image processing unit 16 performs the synthesizing processing of the processed image and the non-target image with respect to the image data processed as described above, based on the position where the processed image is to be arranged and the reflection ratio related to the setting received through the operating unit 11.

In addition, the image processing unit 16 performs processing, such as shading correction for correcting the image so as to have uniform luminance against brightness unevenness, segmentation processing for segmenting pixels related to the inputted image data into a text region, a photographic region, and the like, input tone correction, color correction for removing color muddiness based on spectral characteristics of colors (cyan, magenta, yellow) including unnecessary absorption components, black generation and under color removal for generating a black signal from each signal of cyan, magenta, and yellow after the color correction, and subtracting the black signal from each original signal of cyan, magenta, and yellow to form each new signal of cyan, magenta, and yellow, noise processing of the image, smoothing of the image, spatial filter processing for emphasizing a difference between light and shade, and the like.

The image forming unit 17 is provided with a photoreceptor drum, an electric charger for charging the photoreceptor drum, a laser writing device for writing a latent image on the charged photoreceptor drum, a developer for developing the latent image on the photoreceptor drum, a cleaning unit for removing a developer remaining on the photoreceptor drum to renew the photoreceptor drum, and an electrophotographic process unit composed of a transfer device and the like for transferring a toner image on a surface of the photoreceptor drum to the recording paper, wherein the recording paper is fed to the process unit by the paper feeding unit 18, and the image is formed on the recording paper. The paper feeding unit 18 1s provided with a paper cassette for housing a plurality of kinds of recording paper, a pickup roller for introducing the recording paper housed in the paper cassette one sheet at a time, and the like, and it introduces the recording paper housed in the paper cassette one sheet at a time to feed it to the image forming unit 17.

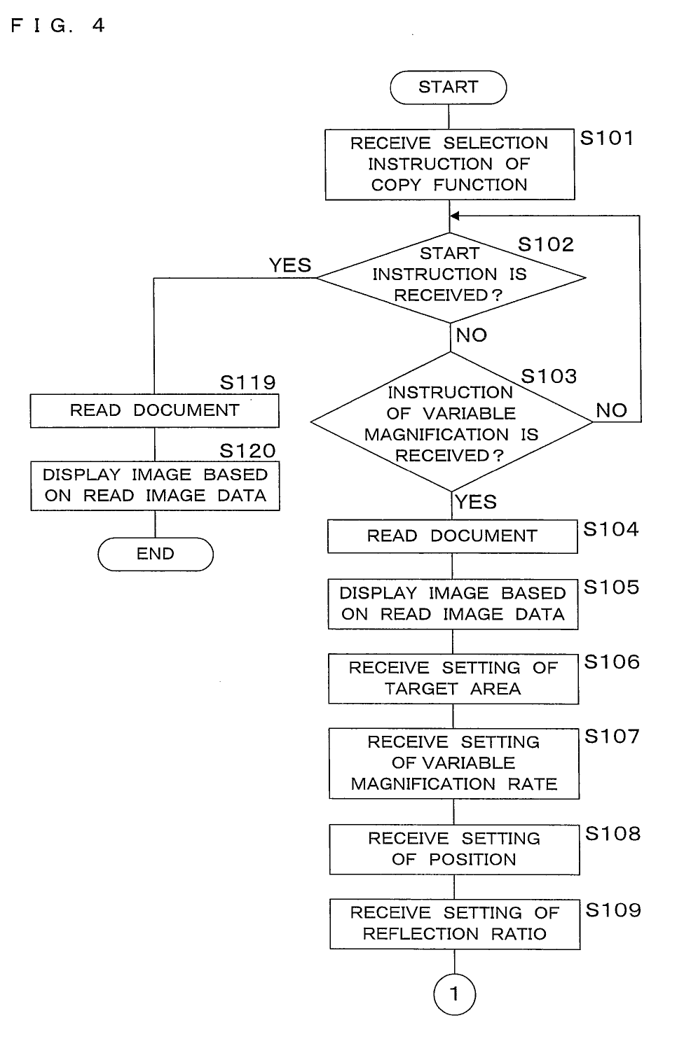

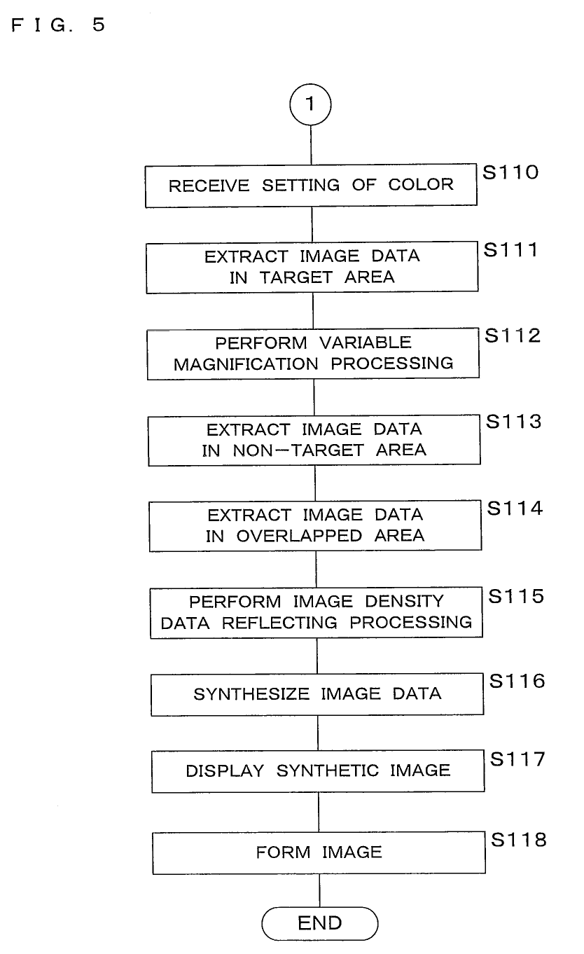

FIG. 4 and FIG. 5 are flow charts showing a procedure of the CPU 10 in the image processing apparatus and the image forming apparatus in accordance with the present invention. For the purpose of explanation, a case where a copy job of the document (equal magnification or variable magnification) is performed using a digital multi-function peripheral will be hereinafter described as an example.

Upon copying the document, the user mounts the document on the scanner platen, and subsequently presses the copy key of the operating unit 11 to select the copy function. Thereafter, the user operates the start key of the operating unit 11 or the “variable magnification” key of the touch panel. Namely, when the user wants an equal magnification copy, the user operates the start key immediately after mounting the document on the scanner platen, but when the user wants a variable magnification copy, the user operates the “variable magnification” key to set the variable magnification rate and the like after mounting the document on the scanner platen.

When the CPU 10 receives a selection instruction of the copy function by the user pressing the copy key of the operating unit 11 (S101), it is determined whether or not an instruction to start the copy job is received (S102). This determination is made by monitoring the operation of the start key of the operating unit 11. When the CPU 10 determines that the instruction to start the copy job is not received (S102: NO), it is determined whether or not an instruction of the variable magnification copy is received (S103). This determination is made by monitoring the operation of the “variable magnification” key of the touch panel.

When the CPU 10 determines that the instruction of the variable magnification copy is not received (S103: NO), the procedure is returned to S102 and the CPU 10 determines again whether or not the instruction to start the copy job is received. Meanwhile, when the CPU 10 determines that the instruction of the variable magnification copy is received (S103: YES), it instructs to the image reading unit 13 to read the document (S104). The image data obtained by the image reading unit 13 is stored in the buffer memory 15.

Next, the CPU 10 displays on the display unit 12 the image of the document based on the image data currently stored in the buffer memory 15 (S105) (refer to FIG. 2B). In addition, the cursor 5 is displayed on the display unit 12 by the user operating the “area setting” key of the touch panel, and the position or size of the cursor 5 is adjusted, and the setting of the target area 7 is performed by the user operating any “moving” key or the copy key. In this case, the CPU 10 receives the setting of the target area 7 by monitoring the operations of the “area setting” key, the “moving” key, and the copy key (S106).

Thereafter, the user operates the “magnification rate setting” key of the touch panel, and subsequently operates the ten-key pad of the operating unit 11 to thereby input the magnification rate. The CPU 10 receives the setting of the variable magnification rate by monitoring the operations of the “magnification rate setting” key and the ten-key pad, (S107).

Subsequently, the user performs the setting the position where the processed image is to be arranged in the synthesis. First, the user operates the “position setting” key of the touch panel, causes the display unit 12 to blinkingly display the cross mark 6, and moves the mark 6 to a suitable position by operating any “moving” key. The CPU 10 receives the setting of the position where the processed image is to be arranged by monitoring the operations of the “position setting” key and the “moving” key (S108).

In addition, the user operates the “reflection ratio” key of the touch panel, and subsequently operates the ten-key pad of the operating unit 11 to thereby input the reflection ratio. The CPU 10 receives the setting of the reflection ratio by monitoring the operations of the “reflection ratio” key and the ten-key pad (S109).

It is to be noted that the user operates the “color setting” key of the touch panel, and subsequently operates the ten-key pad of the operating unit 11 to thereby input the color of the object in the processed image. When the user operates the “color setting” key of the touch panel, a plurality of color names are listed on the display unit 12 while being associated with numbers, and operating the ten-key pad and selecting any of the numbers allows the color selection. In this case, the CPU 10 receives the setting of the color of the object in the processed image by monitoring the operations of the “color setting” key and the ten-key pad (S110).

Next, the CPU 10 extracts image data in the target area 7 from the image data of the document that is obtained by the image reading unit 13 and stored in the buffer memory 15, based on the setting of the target area that is received at S106 (S111), and performs the variable magnification processing on the image data (S112). This variable magnification processing is performed based on the setting of the variable magnification rate that is received at S107. The processed image is obtained based on the image data subjected to the processing described above.

Subsequently, the color of the object of the processed image is processed based on the setting of the color in the object, which is received at S110.

Next, the CPU 10 extracts from the image of the document the data in the non-target area except for the target area 7 (S113). This extraction is performed based on the image data of the document currently stored in the buffer memory 15, and the setting of the target area that is received at S106.

The CPU 10 extracts the image data in the overlapped area where the non-target image and the processed image overlap with each other in the synthesis (S114), and performs image density data reflecting processing on the overlapped area (S115). Namely, the CPU 10 arranges the processed image based on the setting of the position that is received at S108, and extracts the image data in the overlapped area where the non-target image and the processed image overlap with each other when the processed image is synthesized with the non-target image. Subsequently, the reflection processing of the image density data of the processed image and that of the non-target image is performed to the overlapped area at a ratio based on the setting of the reflection ratio that is received at S109. For example, when a magenta of 100 percent concentration in the processed image and a cyan color of 100 percent concentration in the non-target image are synthesized with each other in the pixels of the overlapped area at the reflection ratio of 70 percent, the magenta of 70 percent concentration (100×70/100) in the processed image, and the cyan color of 30 percent concentration (100×30/100) in the non-target image will be a synthesized color of the pixels in the overlapped area.

The CPU 10 performs the processing for synthesizing the image data related to the processed image and the image data related to the non-target image based on such a result of the reflection processing of the image density data (S116), and the synthesized image data is stored in the buffer memory 15. Subsequently, the synthetic image based on the image data stored in the buffer memory 15 is displayed on the display unit 12 (S117). In this case, although the processed image is displayed while partially overlapping with the non-target image in the non-target area except for the target area 7, which is not subjected to any processing, the reflection ratio of the image density data of the processed image is reduced while increasing the reflection ratio of the image density data of the non-target image to thereby form a so-called translucent screen, thus allowing both of the non-target image and the processed image to be visually recognized and to be compared with each other.

The user that has confirmed the synthetic image displayed on the display unit 12 presses the start key of the operating unit 11. By such a user operation, the CPU 10 receives an instruction to form the synthetic image on the recording paper, and instructs to the image forming unit 17 the image formation based on the image data related to the synthetic image displayed on the display unit 12. The image forming unit 17 forms the image on the recording paper based on the image data related to the synthetic image stored in the buffer memory 15 (S118).

Meanwhile, when the CPU 10 determines that the instruction to start the copy job is received at S102 (S102: YES), namely, when the start key of the operating unit 11 is operated by the user, the CPU 10 instructs to the image reading unit 13 to read the document (S119). The image data of the document obtained by the image reading unit 13 is stored in the buffer memory 15. Next, the CPU 10 instructs to the image forming unit 17 to form the image on the recording paper based on the image data of the document stored in the buffer memory 15 (S120).

It is to be noted that although a case where the position of the processed image is changed to synthesize the processed image with the non-target image, and thus both of the images are displayed has been described as an example in the first embodiment, the present invention is not limited thereto. For example, it may be configured such that only the non-target image excluding the target area 7 is displayed.

### Second Embodiment

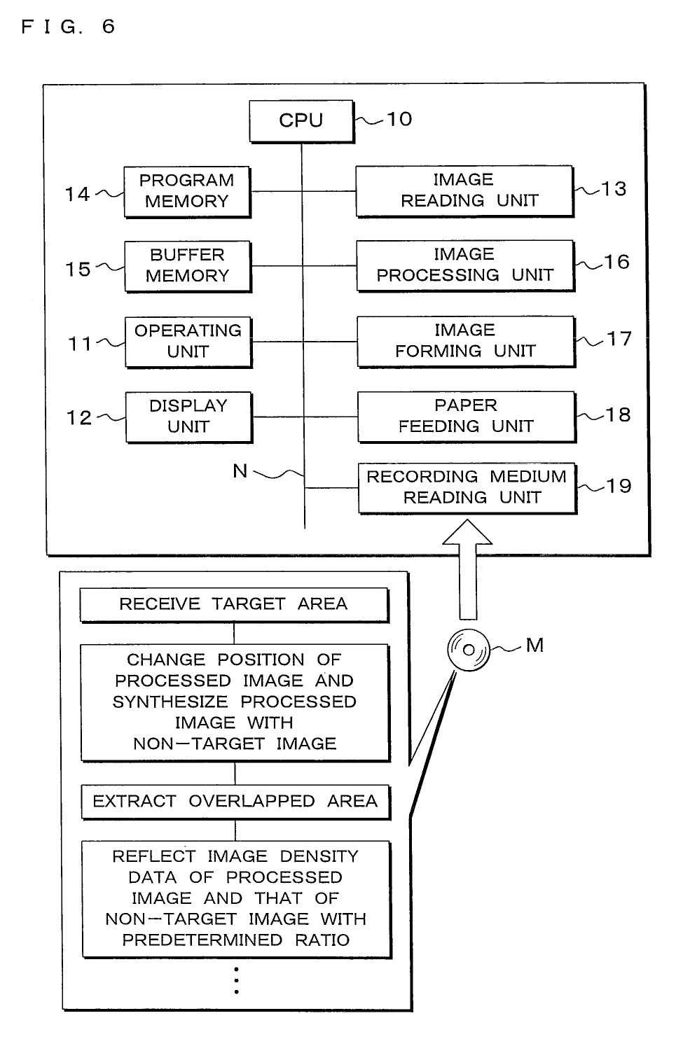

FIG. 6 is a block diagram showing a principal part configuration of an image processing apparatus and an image forming apparatus in accordance with a second embodiment. The image processing apparatus and the image forming apparatus in accordance with the second embodiment are provided with a recording medium reading unit 19. The recording medium reading unit 19 is a reader for reading various data and computer programs stored in the recording medium M, which will be described hereinafter.

The recording medium M includes, for example, a semiconductor memory, such as a mask ROM, an EPROM, an EEPROM, a flash ROM and the like; a magnetic disk, such as a hard disk and the like; disk memories of an optical disk, such as CD-ROM/MO/MD/DVD and the like; or card memories, such as an IC card (including a memory card)/optical card and the like. In addition, the recording medium M is attachable and detachable to the recording medium reading unit 19, and is a medium for storing the data, such as a program and the like.

The computer program stored in the recording medium M includes the aforementioned image processing program, main routine control program, image forming program, storage control program, and bus control program. For example, the recording medium M stores a program for causing a computer to execute the processes of receiving the setting of the target area where processing in the image based on the image data is executed, and changing the position of the processed image in the target area after the processing to synthesize the processed image with the non-target image in the non-target area except for the target area, and when the synthesis is performed, extracting the overlapped area where the non-target image and the processed image overlap with each other, and reflecting the image density data of the processed image and that of the non-target image at a predetermined ratio, with respect to the extracted overlapped area.

The recording medium M is inserted into the recording medium reading unit 19, and it installs the aforementioned programs in the program memory 14. These programs are loaded to the buffer memory 15 to be executed. Thereby, it functions as the above-mentioned image processing apparatus and image forming apparatus of the present invention.

The present second embodiment is configured as described above, and since other configurations and actions are similar to those described in the first embodiment, the same reference numeral is given to a corresponding component, and the detailed description thereof is omitted.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An image processing method for performing a processing on image data, comprising steps of:
receiving a target area to be subjected to the processing in an image based on the image data; and
changing a position of a processed image in the target area subjected to the processing, and synthesizing the processed image with a non-target image in a non-target area except for the target area.

2. The image processing method according to claim 1, further comprising steps of:
extracting an overlapped area where the non-target image and the processed image overlap with each other, when the synthesis is performed; and
performing processing for reflecting image density data of the processed image and that of the non-target image at a predetermined ratio, with respect to the extracted overlapped area.

3. An image processing apparatus for performing a processing on image data, comprising:
an area receiving section for receiving a target area to be subjected to the processing in an image based on the image data; and
a synthesizing section for changing a position of a processed image in the target area subjected to the processing, and synthesizing the processed image with a non-target image in a non-target area except for the target area.

4. The image processing apparatus according to claim 3, further comprising a display section for displaying the image,
wherein the area receiving section receives the target area based on the image displayed on the display section.

5. The image processing apparatus according to claim 3, further comprising a position receiving section for receiving a position where the processed image is to be arranged in the synthesis.

6. The image processing apparatus according to claim 3, further comprising
an extracting section for extracting an overlapped area where the non-target image and the processed image overlap with each other, when the synthesis is performed; and
a reflection processing section for performing processing for reflecting image density data of the processed image and that of the non-target image at a predetermined ratio, with respect to the extracted overlapped area.

7. The image processing apparatus according to claim 6, further comprising a ratio receiving section for receiving the predetermined ratio.

8. The image processing apparatus according to claim 3, further comprising a color receiving section for receiving a color of an object in the processed image.

9. The image processing apparatus according to claim 3, wherein the processing is a variable magnification processing,
the image processing apparatus further comprising a magnification rate receiving section for receiving a variable magnification rate in the variable magnification processing.

10. An image forming apparatus, comprising:
the image processing apparatus according to claim 3; and
an image forming section for forming an image on a recording sheet based on a synthetic image by the image processing apparatus.

11. An image forming apparatus, comprising:
the image processing apparatus according to claim 6; and
an image forming section for forming an image on a recording sheet based on a synthetic image by the image processing apparatus.

12. A recording medium in which a computer program for executing a processing on image data is recorded, said computer program comprising steps of:
causing a computer to receive a target area to be subjected to the processing in an image based on the image data; and
causing a computer to change a position of a processed image in the target area subjected to the processing, and to synthesize the processed image with a non-target image in a non-target area except for the target area.

13. The recording medium according to claim 12, said computer program further comprising steps of:
causing a computer to extract an overlapped area where the non-target image and the processed image overlap with each other, when the synthesis is performed; and
causing a computer to perform processing for reflecting image density data of the processed image and that of the non-target image at a predetermined ratio, with respect to the extracted overlapped area.
